(19) United States
(12) Patent Application Publication
(10) Pub. No.: US 2008/0298925 A1
(43) Pub. Date: Dec. 4, 2008

(54) Two-piece clip

(75) Inventor: Nobuya Shinozaki, Yokohama-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: PIOLAX INC., Yokohama-shi (JP)

(21) Appl. No.: 12/154,749

(22) Filed: May 27, 2008

(30) Foreign Application Priority Data
May 30, 2007 (JP) 2007-142841
Apr. 18, 2008 (JP) 2008-108673

(51) Int. Cl. F16B 13/06

(52) U.S. Cl. 411/48

(57) ABSTRACT

Provided is a two-piece clip that can be detached from a mounting hole easily and reliably. A two-piece clip includes a grommet and a pin. The pin has a flange portion, a shaft portion, and a first lock member to be engaged with the peripheral edge of a mounting hole. A first lock groove is formed in the outer periphery of the distal end portion of the shaft portion, and, further, a second lock groove is formed in the outer periphery of the shaft portion on the proximal end side of the first lock groove. The grommet has a cylinder portion, an opening through which a first lock member is projected and retracted, and an elastic member deflectably formed at the distal end of the cylinder portion and adapted to be engaged with the first lock groove and the second lock groove; when the elastic member is engaged with the first lock groove of the pin, the first lock member protrudes from the opening; and, when the elastic member is engaged with the second lock groove, the first lock member is pressed by the peripheral edge of the opening and drawn into the opening.

### BACKGROUND OF THE INVENTION

1. Field of the Invention

The present invention relates to a two-piece clip equipped with a grommet and a pin and used, for example, to mount one vehicle component to another component.

2. Description of the Related Art

For example, a cover member may be detachably mounted to an opening in a vehicle body panel of a vehicle. As a structure for thus mounting one component detachably to another, there is known a two-piece clip which includes a grommet and a pin.

As a conventional example of a two-piece clip of this type, Japanese Utility Model Application Laid-open No. Hei 04-34507 discloses a two-piece clip (expansion type rivet for plate binding) which includes a grommet (female member) and a pin (male member). In the two-piece clip, the grommet has a flange and elastic leg members extending from the flange while being divided via a split portion and capable of warp, the pin has a head portion and a shaft portion extending from this head portion, and the distal end portions of the elastic leg members are bent inwardly. Further, the distal end portion and the proximal end portion of the shaft portion are reduced in diameter to form recesses, with the intermediate portion thereof being diverged.

When the pin is inserted to a slight degree into the grommet, the distal ends of the elastic leg members are engaged with the recess at the distal end of the shaft portion, and the pin is retained by the grommet. In this state, the grommet is inserted into amounting hole of one component and an insertion hole of another component, and the pin is further forced in, whereby the plurality of elastic leg members are pressed from an inside by the intermediate diverged portion of the shaft portion to be thereby diverged and engaged with the peripheral edge of the mounting hole of one component, and, at the same time, the flange abuts the other component, thereby connecting the two components with each other via the two-piece clip. In this state, the pin is forced in still deeper, whereby protrusions of the elastic leg members are engaged with the recess at the proximal end side of the shaft portion, and the plurality of elastic leg members undergo a reduction in diameter, so it is possible to detach one component from the other by pulling the clip out of the holes.

Japanese Utility Model Publication No. Hei 01-37207 discloses a two-piece clip (fastener) which includes a grommet (outer cylindrical member) and a pin (insertion member); the grommet has a flange portion, a cylinder portion cylindrically protruding from the flange portion, a pair of lock members formed on the opposing side walls of the cylinder portion so as to be capable of warp via a U-shaped slit, and an engagement portion (connecting portion) protruding from the inner side of the distal end of the side wall of the cylinder portion. On the other hand, the pin has an elongated-plate-shaped bar member, a head portion connected to the proximal end portion of the bar member and increased in diameter as compared with the bar member, and a plurality of clip stoppers formed along the longitudinal direction of the bar member and adapted to be engaged with the engagement portion.

When the pin is inserted to a slight degree into the grommet, the clip stoppers on the distal end side of the bar member are engaged with the engagement portion of the grommet, and the pin is retained by the grommet. In this state, the grommet is inserted into a mounting hole of one component and an insertion hole of another component, whereby the pair of lock members are engaged with the peripheral edge of the mounting hole of one component, and the flange portion abuts the other component, thereby connecting the two components with each other. When the pin is further forced in, the head portion of the pin is fitted into the gap between the pair of lock members, whereby the warp of the pair of lock members is suppressed, and the clip is firmly fixed to the mounting hole. In this state, the pin is forced in still deeper, whereby the head portion of the pin moves from the position between the pair of lock members to a lower position, and the lock members become capable of warp, and by pulling the clip out of the holes, the two components can be detached from each other.

In Japanese Utility Model Application Laid-open No. Hei 04-34507, by forcing the pin into the grommet, the elastic leg members in the outer periphery of the grommet are pressed from an inside and diverged. However, when the elastic leg members are left in the diverged state over a long period of time, the elastic leg members undergo transition to the diverged state with the passage of time. As a result, the elastic restoring force is weakened, and, even when the pin is further forced-in in order to pull the clip out of the holes, the elastic leg members are not restored to the contracted state, thus making it rather difficult to pull the clip out of the holes.

In Japanese Utility Model Examined Publication No. Hei 01-37207, in the state in which the clip is fixed to the mounting hole, the pin is further forced in to move the head portion from between the pair of lock members to thereby make the pair of lock members capable of warp, thereby enabling the clip to be detached from the hole. In this state, however, the pair of lock members provided on the grommet remain engaged with the peripheral edge of the mounting hole. Thus, when pulling the clip out of the holes, the pair of lock members may be caught by the peripheral edge of the mounting hole. In this case also, it is rather difficult to pull the clip out of the holes, resulting in a rather poor workability when detaching the two components from each other.

### SUMMARY OF THE INVENTION

It is therefore an object of the present invention to provide a two-piece clip that can be detached easily and reliably from a mounting hole.

In order to achieve the above-mentioned object, according to a first aspect of the present invention, there is provided a two-piece clip, including a grommet and a pin inserted into the grommet, and adapted to be fixed to a mounting hole, in which the pin has a flange portion, a shaft portion protruding from one surface of the flange portion, and a first lock member provided as to be warped to the outer periphery of the shaft portion and adapted to be engaged with a peripheral edge of the mounting hole, in which the grommet has a cylinder portion into which the shaft portion is inserted and which has an inner diameter smaller than the outer diameter of the flange portion, and an opening which is formed in a peripheral wall of the cylinder portion and from and into which the first lock member is projected and retracted, in which the two-piece clip further includes a first engagement means for retaining the pin with respect to the grommet so as to prevent detachment thereof, with the pin being forced into the grommet to a predetermined depth, the first lock member protruding from the opening, and a predetermined gap being provided between the grommet and the flange portion, and in which the two-piece clip further includes a second engagement means which is constructed such that, by further forcing the pin into the grommet from the state in which the pin is retained with respect to the grommet so as to prevent detachment thereof by the first engagement means, the first lock member is pressed against the peripheral edge of the opening and drawn into the opening, with the pin being retained by the grommet at that forcing-in position.

According to the first aspect of the present invention described above, the pin is forced into the grommet, and the shaft portion of the pin is inserted into the inner periphery of the cylinder portion of the grommet, with the first lock member of the pin being projected from the opening provided in the grommet; in this state by the first engagement means, it is possible to retain the pin with respect to the grommet so as to prevent its detachment therefrom. Further, in this state, the cylinder portion of the grommet and the shaft portion of the pin are inserted into the mounting hole, whereby the first lock member of the pin is engaged with the peripheral edge of the mounting hole, making it possible to mount the clip to the mounting hole. At this state, when there is a mounting component to be fixed to the mounting object component with the mounting hole, the cylinder portion of the grommet and the shaft portion of the pin are first inserted into the insertion hole provided in the mounting component, and then inserted into the mounting hole of the mounting object component.

In this state, a predetermined gap is formed between the grommet and the flange portion, so it is possible to further force the pin into the grommet. Thus, when the clip is to be detached from the mounting hole, the pin is further forced-in in the above state, whereby the first lock member protruding from the opening is pressed by the peripheral edge of the opening to be warped inwardly, and drawn into the opening. At the same time, the pin is retained by the grommet at that forcing-in position by the second engagement means. As a result, the first lock member is detached from the peripheral edge of the mounting hole, so, by pulling the clip out of the mounting hole in this state, it is possible to detach the clip from the mounting hole. In this way, detachment of the clip from the mounting hole can be easily effected by a relatively simple operation of forcing the pin into the grommet and then pulling the clip out.

Further, in this clip, the outer periphery of the grommet is not forcibly diverged by forcing in the pin as in the related art, so there is no fear of the diverged portion undergoing transition to the diverged state with the passage of time to become incapable of allowing detachment. By forcing in the pin deep, and causing the grommet to retain the pin by the second engagement means, the first lock member of the pin is forcibly reduced in diameter, so, when pulling the clip out of the mounting hole, the clip is not caught by the peripheral edge thereof, thus making it possible to reliably perform the operation of removing the clip. Further, there is no need to provide an elastic portion to be greatly diverged in the grommet, so it is possible to adopt, for example, a relatively hard synthetic resin material, thus enlarging the range of material selection.

According to a second aspect of the present invention, in the first aspect of the invention, there is provided a two-piece clip in which the first engagement means includes a first lock groove formed in the outer periphery of the forward end portion of the shaft portion of the pin, and an elastic member formed at the forward end portion of the cylinder portion of the grommet so as to be capable of warp, and in which the second engagement means includes a second lock groove formed in the outer periphery of the shaft portion of the pin on the proximal end portion side of the first lock groove, and the elastic member.

According to the second aspect of the present invention described above, when the pin is forced into the grommet to a slight degree, the elastic member of the grommet is engaged with the first lock groove of the pin, making it possible to assemble the pin to the grommet, with the first lock member protruding from the opening of the grommet. When, in this state, the pin is forced in still deeper, the elastic member is detached from the first lock groove, and is engaged with the second lock groove, and, at the same time, the first lock member protruding from the opening is pressed by the peripheral edge of the opening to be inwardly warped and drawn into the opening, enabling the grommet to be retained by the pin at that forcing-in position.

According to a third aspect of the present invention, in the second aspect of the invention, there is provided a two-piece clip in which the first lock groove is formed so as to be deeper than the second lock groove with respect to the outer peripheral surface of the shaft portion.

According to the third aspect of the present invention described above, the first lock groove is formed deeper than the second lock groove, so, when the elastic member is engaged with the first lock groove, it is possible to make it difficult for the elastic member to be detached from the first lock groove. Thus, when the elastic member is engaged with the first lock groove, it is possible to firmly maintain the state in which the first lock member protrudes from the opening, and it is possible to maintain in a stable manner the state in which the clip in this condition is inserted into and fixed to the mounting hole.

Further, when the elastic member is engaged with the second lock groove, the elastic member is more diverged than when it is engaged with the first lock groove, so it is easier for the elastic member to return to the first lock groove side due to the elastic force thereof. Thus, after causing the first lock member to be retracted into the opening to detach the clip from the mounting hole, the elastic member is easily restored to the state in which the elastic member is engaged with the first lock groove by reversely forcing the pin from the distal end thereof into the grommet a little, and it is possible to restore the state in which the first lock member protrudes from the opening, so re-use of the clip is facilitated.

According to a fourth aspect of the present invention, in the second aspect of the invention, there is provided a two-piece clip in which, in the shaft-portion-distal-end-side peripheral edge of the first lock groove, there is formed a stopper wall protruding further outwards than the shaft-portion-proximal-end-side peripheral edge of the first lock groove.

According to the fourth aspect of the present invention described above, the stopper wall protruding further outwards is provided at the peripheral edge on the shaft portion distal end side of the first lock groove, so it is possible to make it difficult for the elastic member to be detached from the first lock groove, and there is no fear of the pin being easily pulled out of the grommet.

According to a fifth aspect of the present invention, in the second aspect of the invention, there is provided a two-piece clip in which, when the elastic member is engaged with the first lock groove, and the first lock member protrudes from the opening, the cylinder-portion-distal-end-side peripheral edge of the opening is situated in the vicinity of the proximal end portion of the first lock member.

According to the fifth aspect of the present invention described above, the elastic member is engaged with the first lock groove, and the cylinder-portion-distal-end-side peripheral edge of the opening is situated in the vicinity of the proximal end portion of the first lock member, with the first lock member protruding from the opening, so, when the pin is forced into the grommet, the first lock member is immediately pressed by the distal-end-side peripheral edge of the opening and is warped inwardly, so it is possible to shorten the forcing-in stroke of the pin, thereby achieving an improvement in terms of detachment workability.

According to a sixth aspect of the present invention, in the first aspect of the invention, there is provided a two-piece clip in which the first engagement means includes the first lock groove formed in the outer periphery of the forward end portion of the shaft portion of the pin, and the elastic member formed at the forward end portion of the cylinder portion of the grommet so as to be capable of warp, and in which the second engagement means includes a second lock member formed on the shaft portion of the pin on the proximal end portion side of the first lock member, and a proximal-end-side peripheral edge of the opening of the cylinder portion of the grommet.

According to the sixth aspect of the present invention described above, when the pin is forced into the grommet to a slight degree, the elastic member of the grommet is engaged with the first lock groove of the pin, and it is possible to retain the pin in the grommet so as to prevent detachment thereof, in the state in which the first lock member of the pin protrudes from the opening of the grommet. When, in this state, the pin is forced in still deeper, the elastic member is detached from the first lock groove, and, at the same time, the first lock member protruding from the opening is pressed by the peripheral edge of the opening and is warped inwardly to be drawn into the opening. Further, the second lock member at proximal end side of the pin is engaged with the proximal-end-side peripheral edge of the opening of the cylinder portion of the grommet, enabling the grommet to retain the pin at that forcing-in position.

According to a seventh aspect of the present invention, in the sixth aspect of the invention, there is provided a two-piece clip in which, in the shaft-portion-distal-end-side peripheral edge of the first lock groove, there is formed a stopper wall protruding further outwards than the shaft-portion-proximal-end-side peripheral edge of the first lock groove.

According to the seventh aspect of the present invention described above, the stopper wall protruding further outwards is provided at the peripheral edge on the shaft portion distal end side of the first lock groove, so it is possible to make it difficult for the elastic member to be detached from the first lock groove, and there is no fear of the pin being easily pulled out of the grommet.

According to a eighth aspect of the present invention, in the sixth aspect of the invention, there is provided a two-piece clip in which, when the elastic member is engaged with the first lock groove, and the first lock member protrudes from the opening, the cylinder-portion-distal-end-side peripheral edge of the opening is situated in the vicinity of the proximal end portion of the first lock member.

According to the eighth aspect of the present invention described above, the elastic member is engaged with the first lock groove, and the cylinder-portion-distal-end-side peripheral edge of the opening is situated in the vicinity of the proximal end portion of the first lock member, with the first lock member protruding from the opening, so, when the pin is forced into the grommet, the first lock member is immediately pressed by the distal-end-side peripheral edge of the opening and is warped inwardly. As a result, it is possible to shorten the forcing-in stroke of the pin, thereby achieving an improvement in terms of detachment workability.

According to a ninth aspect of the present invention, in the first aspect of the invention, there is provided a two-piece clip in which the grommet is formed integrally with a component to be fixed to the mounting hole.

According to the ninth aspect of the present invention described above, the grommet is formed integrally with the component to be fixed to the mounting hole, so it is possible to reduce the number of parts of the clip, and the clip can be temporarily fixed to the component solely by inserting the shaft portion of the pin into the grommet.

In the two-piece clip of the present invention, the pin is forced into the grommet, and is retained so as not to be detached from the grommet by the first engagement means. In this state, the clip is inserted into the mounting hole, whereby the first lock member protruding from the opening of the grommet is engaged with the peripheral edge of the mounting hole, thus making it possible to mount the clip to the mounting hole. By further forcing in the pin in this state, the first lock member is pressed by the peripheral edge of the opening and is drawn in, and the first lock member is detached from the peripheral edge of the mounting hole, so it is possible to remove the clip from the mounting hole.

Further, this clip does not adopt a construction in which the outer periphery of the grommet is forcibly diverged by forcing in the pin, so there is no fear of the diverged portion undergoing transition to the diverged state with passage of time to become incapable of being detached. Further, when the pin is forced in deep and is retained at a predetermined forcing-in position with respect to the grommet by the second engagement means, the first lock member of the pin is forcibly reduced in diameter. Therefore, when pulling the clip out of the mounting hole, it is not caught by the peripheral edge thereof, thus making it possible to perform the clip removing operation easily and reliably.

### BRIEF DESCRIPTION OF THE DRAWINGS

In the accompanying drawings:

FIG. 1 is an exploded perspective view of a two-piece clip according to a first embodiment of the present invention;

FIG. 2 is a perspective view, as seen obliquely from below, of the two-piece clip;

FIGS. 3A and 3B illustrate a grommet constituting the two-piece clip, of which FIG. 3A is a front view, and FIG. 3B is a bottom view;

FIGS. 4A, 4B, and 4C illustrate a pin constituting the two-piece clip, of which FIG. 4A is a front view, FIG. 4B is a side view, and FIG. 4C is a bottom view;

FIG. 5 is an explanatory view illustrating how the two-piece clip is fixed to a mounting hole;

FIG. 6 is an explanatory view illustrating how the two-piece clip is removed from the mounting hole;

FIG. 7 is an explanatory view of a two-piece clip according to a second embodiment of the present invention;

FIGS. 8A, 8B, and 8C illustrate a two-piece clip according to a third embodiment of the present invention, of which FIG. 8A is a front view of a pin constituting the two-piece clip, FIG. 8B is a side view of the pin, and FIG. 8C is a bottom view of the pin;

FIG. 9 is an explanatory view illustrating how the two-piece clip is fixed to a mounting hole;

FIG. 10 is an explanatory view illustrating how the two-piece clip is detached from the mounting hole;

FIG. 11 is an exploded perspective view of a two-piece clip according to a fourth embodiment of the present invention;

FIG. 12 is a perspective view of a pin constituting the two-piece clip;

FIG. 13 is a perspective view of a grommet constituting the two-piece clip;

FIGS. 14A, 14B, and 14C illustrate a pin constituting the two-piece clip, of which FIG. 14A is a front view, FIG. 14B is a side view, and FIG. 14C is a bottom view;

FIG. 15 is an explanatory view illustrating how a pin is assembled to a grommet;

FIG. 16 is an explanatory view illustrating how a two-piece clip according to the present invention is fixed to a mounting hole;

FIG. 17 is an explanatory view illustrating how the two-piece clip is fixed to a mounting hole of a member with a large thickness;

FIG. 18 is an explanatory view illustrating how the two-piece clip is detached from the mounting hole;

FIG. 19 is an explanatory view of a two-piece clip according to a fifth embodiment of the present invention, illustrating how the two-piece clip is fixed to a mounting hole;

FIG. 20 is an explanatory view illustrating how the two-piece clip is detached from the mounting hole;

FIGS. 21A, 21B, and 21C illustrate a two-piece clip according to a sixth embodiment of the present invention, of which FIG. 21A is a front view of a pin constituting the two-piece clip, FIG. 21B is a side view of the pin, and FIG. 21C is a bottom view of the pin;

FIG. 22 is an explanatory view illustrating how the two-piece clip is fixed to a mounting hole; and

FIG. 23 is an explanatory view illustrating how the two-piece clip is detached from the mounting hole.

### DETAILED DESCRIPTION OF THE PREFERRED EMBODIMENTS

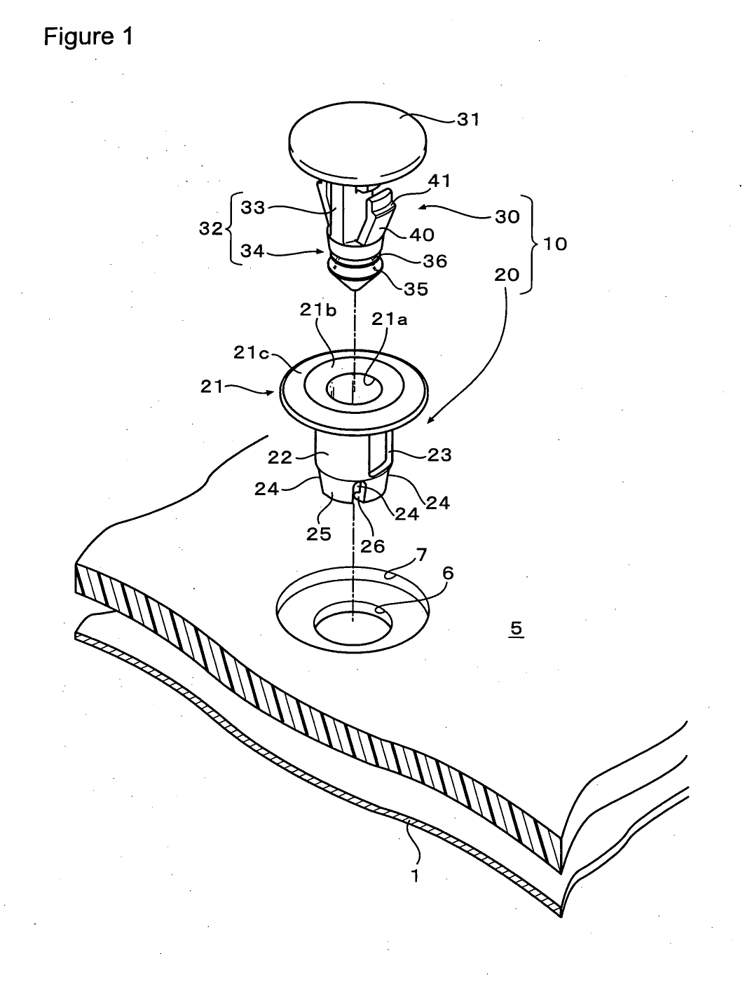

In the following, a two-piece clip according to the first embodiment of the present invention is described with reference to FIGS. 1 through 6.

For example, in the engine room of a vehicle, there are arranged various components, such as an engine main body, a battery, an air cleaner, and a washer tank. Conventionally, these components have often been exposed within the engine room. However, when the vehicle collides with a pedestrian or the like, and the pedestrian or the like is hit hard by the front hood, the above-mentioned components arranged in the engine room may break open the front hood and injure the body of the pedestrian or the like. In view of this, it has become common practice to cover each of the various components arranged in the engine room with a cover member. It is necessary for this cover member to be capable of being easily removed when the component is to undergo maintenance, is to be replaced, or cleaned.

The two-piece clip of this embodiment of the present invention is suitably used when detachably mounting a cover member 5 to a vehicle body panel 1 arranged in a vehicle engine room as described above (see FIG. 1). This mode, however, should not be construed restrictively; the two-piece clip of the present invention is also applicable when fixing a mounting member such as an interior member (for example, a garnish or a trim board) to a mounting object member such as a vehicle panel member or when connecting together a plurality of panel members.

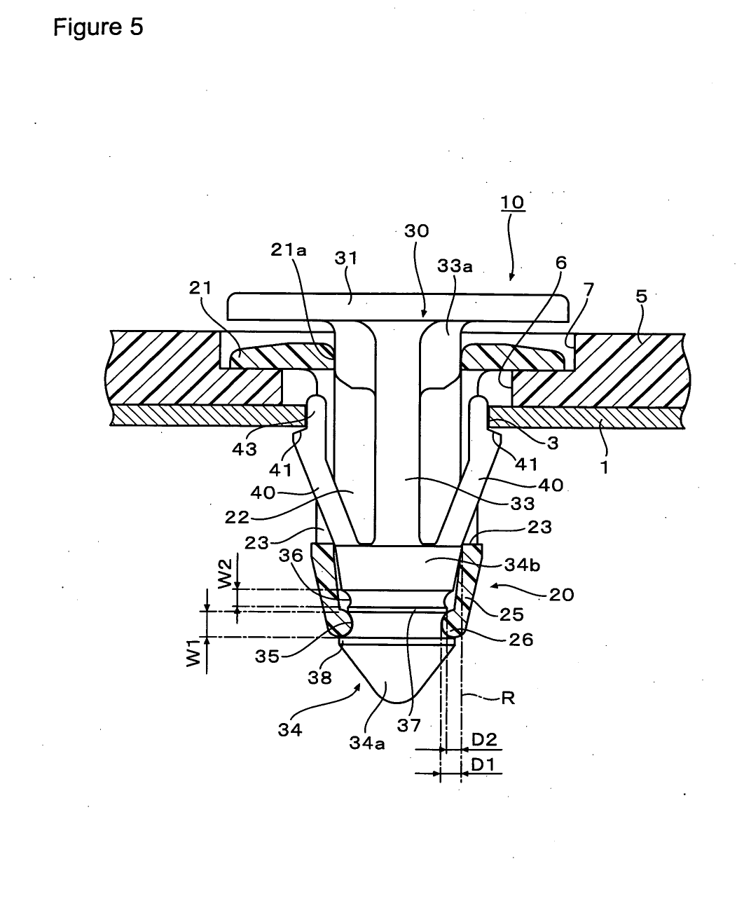

As illustrated in FIG. 1, a two-piece clip 10 according to this embodiment (hereinafter referred to as “clip 10”) is equipped with a grommet 20 and a pin 30 to be inserted into the grommet 20. A circular mounting hole 3 (see FIG. 5) is formed in the vehicle body panel 1. The cover member 5 has a circular insertion hole 6 at a position matched with the mounting hole 3 of the vehicle body panel 1, and a circular recess 7 is formed at the front side peripheral edge of the insertion hole 6. While actually a plurality of mounting holes 3 and insertion holes 6 are provided in the vehicle body panel 1 and the cover member 5, only one of them is illustrated here for the sake of convenience in illustration.

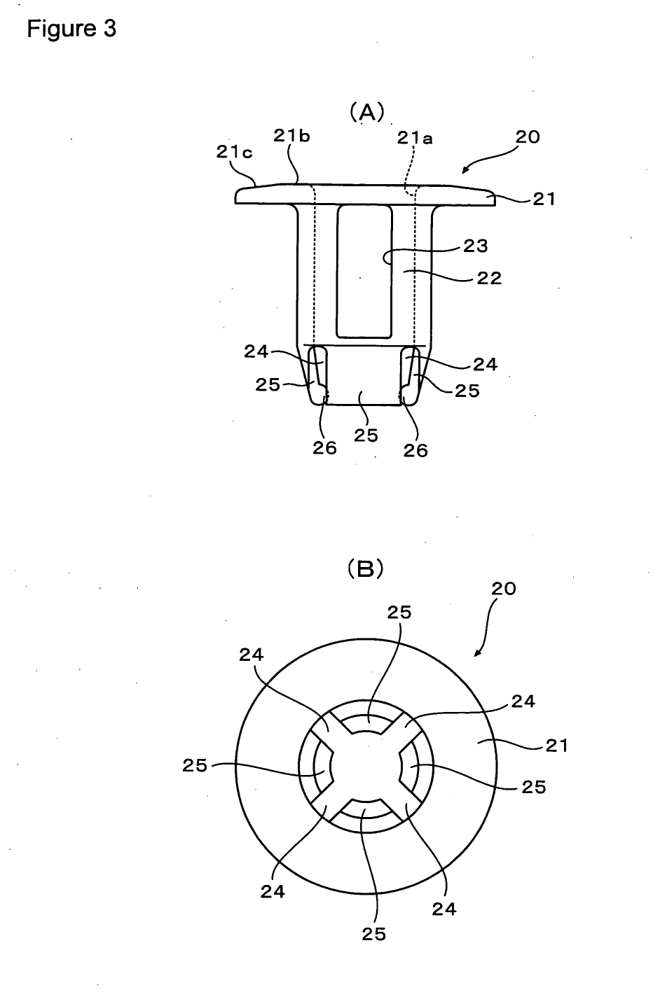

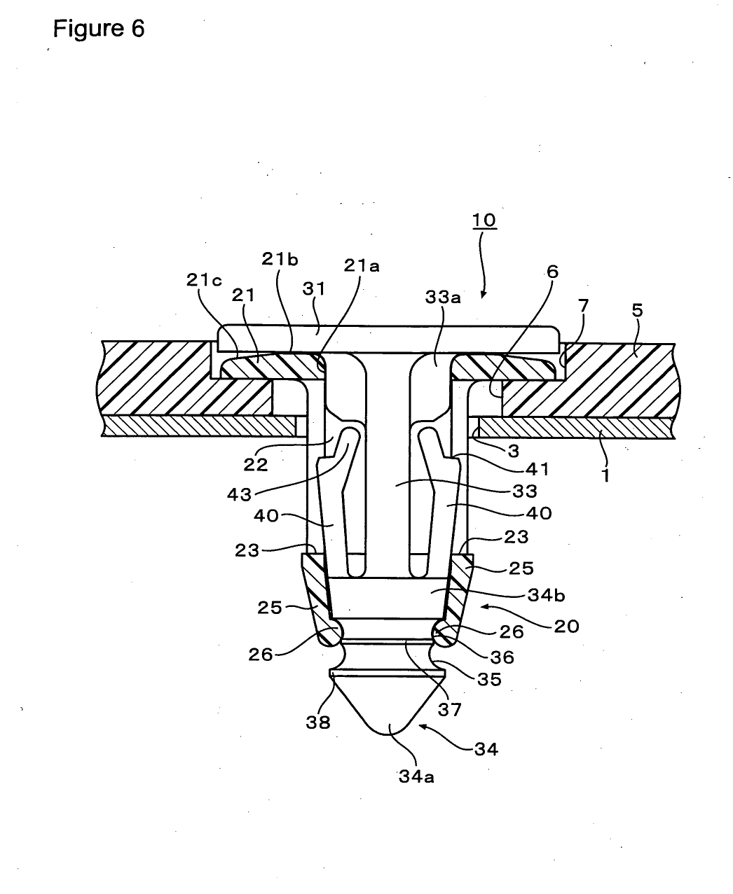

The grommet 20 is described with reference to FIGS. 1 through 3, 5, and 6; the grommet 20 is formed in a substantially annular configuration with a circular insertion hole 21a being provided at the center thereof, and has a head portion 21 to be engaged with the front side peripheral edge of the insertion hole 6 of the cover member 5, and a cylinder portion 22 which protrudes cylindrically from the back side peripheral edge of the insertion hole 21a of the head portion 21 and into which a shaft portion 32 of the pin 30 described below is inserted. The inner diameter of the cylinder portion 22 is set smaller than the outer diameter of a flange portion 31 of the pin 30, and the flange portion 31 of the pin 30, which is inserted into the cylinder portion 22 through the insertion hole 21a, is engaged with the upper opening edge of the cylinder portion 22. The peripheral edge of the insertion hole 21a formed on the front side of the head portion 21 constitutes a circular flat surface 21b, and a tapered surface 21c gradually reduced in thickness extends radially outwards from the peripheral edge of the flat surface 21b (see FIG. 3A). The flat surface 21b is a portion which abuts the back surface of the flange portion 31 of the pin 30 described below when the pin 30 is forced into the grommet 20 to the maximum depth. In this state, the tapered surface 21c secures a gap between the surface of the head portion 21 and the back surface of the flange portion 31, thereby enabling the grommet 20 and the pin 30 to be easily separated from each other (see FIG. 6).

At opposing positions of the peripheral wall of the cylinder portion 22, there are formed a pair of elongated-hole-shaped openings 23, 23 that allow first lock members 40 of the pin 30 described below to project and retract therethrough. The elongated-hole-shaped openings 23 extend axially halfway through from the proximal end edge of the cylinder portion 22 (see FIG. 3A). Further, the peripheral edges of the openings 23 on the distal end side of the cylinder portion 22 are formed so as to be arranged in the vicinity of the proximal ends of the first lock members 40 when engagement protrusions 26 at the distal ends of elastic members 25 described below are engaged with a first lock groove 35 of the pin 30 described below, and the first engagement members 40 (described below) protrude from the openings 23.

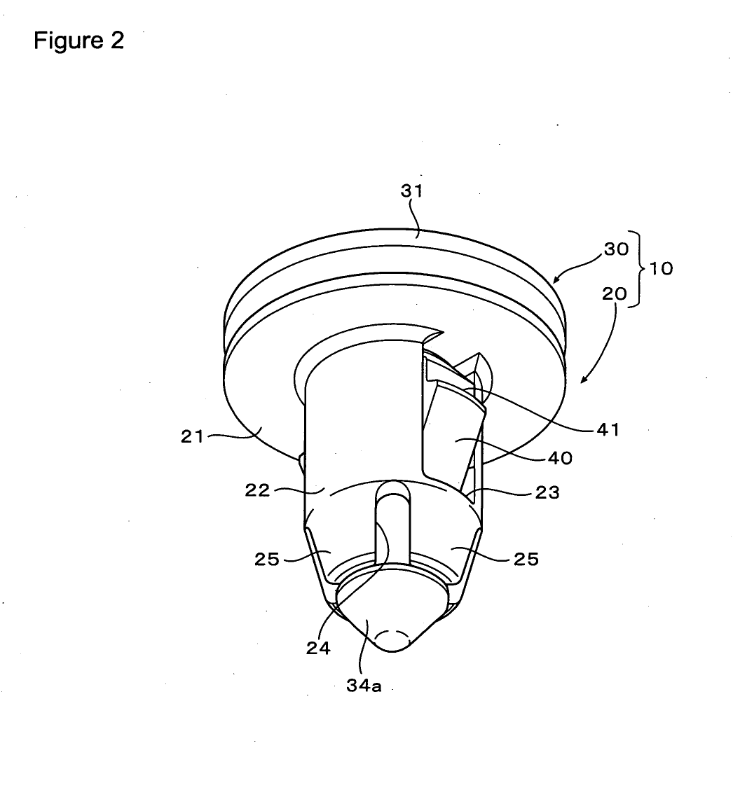

As illustrated in FIG. 2, the portion of the cylinder portion 22 on the distal end side with respect to the openings 23 is gradually reduced in diameter toward the distal end. To describe it also with reference to FIG. 3B, this portion reduced in diameter has a plurality of (four, in this embodiment) slits 24 provided at equal circumferential intervals, forming a plurality of (four, in this embodiment) elastic members 25 capable of being warped through the intermediation of the plurality of slits 24. Each elastic member 25 has on the inner side of the distal end portion thereof an engagement protrusion 26 of a predetermined height, which is to be engaged with a first lock groove 35 and a second lock groove 36 of the pin 30 described below. The engagement protrusion 26 is formed as a protrusion of an arcuate sectional configuration, and is to be firmly engaged with the first lock groove 35 and the second lock groove 36, which are recessed in an arcuate configuration (see FIG. 5).

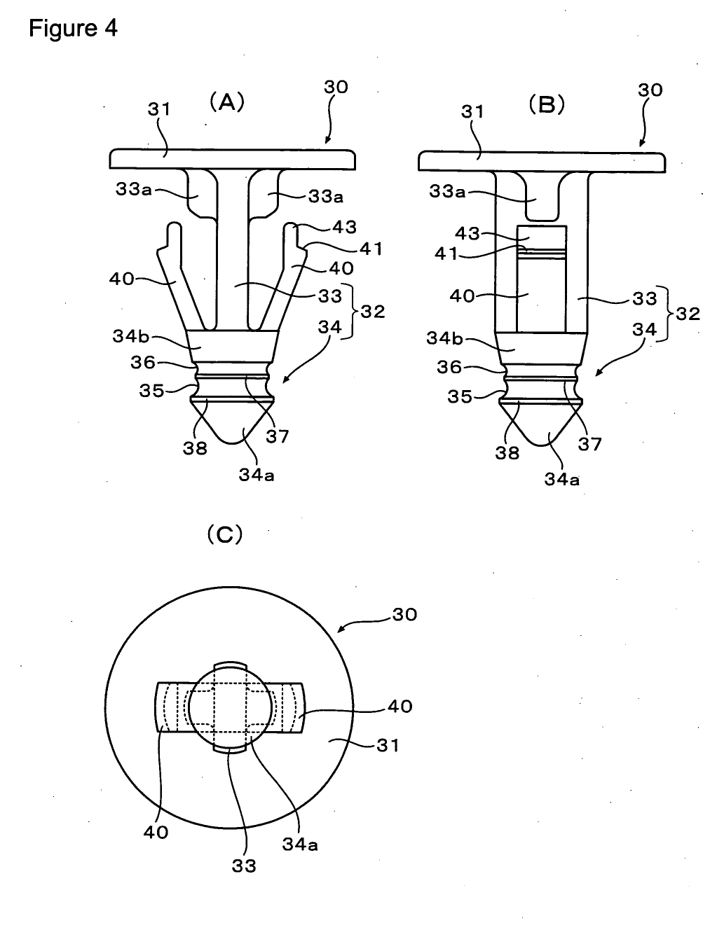

Next, the pin 30 to be inserted into the above-mentioned grommet 20 is described with reference to FIGS. 1, 2, and 4 through 6. The pin 30 has a flange portion 31 formed in a disc-like configuration and adapted to abut the head portion 21 of the grommet 20, and a shaft portion 32 protruding from one surface of the flange portion 31. The shaft portion 32 has an elongated-plate-shaped shaft main body 33 protruding perpendicularly from the center of the back surface of the flange portion 31, and a diverged portion 34 connected to the distal end of the shaft main body 33. As illustrated in FIG. 4A, a pair of protrusions 33a, 33a protrude from both side surfaces in the thickness direction at the proximal end of the shaft main body 33. The pair of protrusions 33a, 33a are fitted onto the inner periphery of the cylinder portion 22 of the grommet 20 when the pin 30 is assembled to the grommet 20, preventing inclination and rattling of the pin 30 and making it possible to firmly assemble the pin 30 to the grommet 20 (see FIGS. 5 and 6).

The distal end portion 34a of the diverged portion 34 of the shaft portion 32 is tapered toward the distal end, thus facilitating the insertion of the shaft portion 32 of the pin 30 into the cylinder portion 22 of the grommet 20. Further, the outer peripheral surface of the proximal end portion 34b of the diverged portion 34 is gradually increased in diameter toward the proximal end side of the shaft portion 32, and, as illustrated in FIG. 6, the outer periphery of the proximal end portion 34b is substantially adapted to the inner periphery of the elastic members 25.

The first lock groove 35 of a predetermined depth is formed between the distal end portion 34a and the proximal end portion 34b of the diverged portion 34 and formed in the outer periphery on the distal end side of the shaft portion 32, and the second lock groove 36 of a predetermined depth is formed in the outer periphery on the proximal end side of the first lock groove 35. In the case of this embodiment, the first lock groove 35 and the second lock groove 36 are vertically adjacent to each other with a partition wall 37 formed therebetween. Further, the inner peripheral surfaces of the lock grooves 35, 36 are recessed in an arcuate configuration in correspondence with the engagement protrusions 26 at the distal ends of the elastic members 25 of an arcuate sectional configuration.

As illustrated in FIG. 5, the first lock groove 35 is formed at the most diverged outer peripheral edge R of the diverged portion 34 to a depth D1, and the depth D1 is larger than the depth D2 of the second lock groove 36 as measured from the outer peripheral edge R (D1>D2). The width W1 of the first lock groove 35 is larger than the width W2 of the second lock groove 36 (W1>W2). Further, as illustrated in FIG. 5, at the peripheral edge of the first lock groove 35 on the shaft-portion-32-distal-end side, there is provided a stopper wall 38 protruding further outwards than the partition wall 37 provided at the shaft-portion-32-proximal-end-side peripheral edge of the first lock groove 35.

Further, as illustrated in FIG. 5, the first lock groove 35 is arranged at a predetermined position of the distal end portion of the shaft portion 32 such that a gap of a predetermined dimension is formed between the head portion 21 of the grommet 20 and the flange portion 31 of the pin 30 when the pin 30 is assembled to the grommet 20 through engagement of the engagement protrusions 26 of the elastic members 25 of the grommet 20 with the first lock groove 35 of the pin 30. As a result, in the state in which the pin 30 is assembled to the grommet 20 through engagement of the engagement protrusions 26 with the first lock groove 35 illustrated in FIG. 5, the pin 30 can be further forced into the grommet 20. Further, in the assembled state of the grommet 20 and the pin 30 illustrated in FIG. 5, the upper end surface of the proximal end portion 34b of the diverged portion 34 is substantially at the same position as the peripheral edges of the openings 23 of the distal end side of the cylinder portion 22 formed on the grommet 20, whereby the peripheral edges of the openings 23 at the distal end of the cylinder portion 22 is arranged in the vicinity of the proximal end portions of the first lock members 40 described below.

From the upper end surface of the proximal end portion 34b of the diverged portion 34, there extend a pair of first lock members 40, 40 obliquely outwards toward the proximal end of the shaft portion 32 in a fluke-like fashion so as to be situated on both side surfaces of the shaft main body 33 in the thickness direction. Further, at the distal ends of the first lock members 40, 40, there are provided first engagement step portions 41, 41; from the inner peripheral sides of the first engagement step portions 41, 41, there protrude thin portions 43, 43 substantially parallel to the shaft main body 33. The first engagement step portions 41, 41 are portions to be engaged with the back side peripheral edge of the mounting hole 3; in the engagement process, the thin portions 43, 43 are inserted into the inner periphery of the mounting hole 3.

When the pin 30 is forced into the grommet 20 to a predetermined depth, and the engagement protrusions 26 of the elastic members 25 are engaged with the first lock groove 35, the pair of lock members 40, 40 protrude from the openings 23, 23, and, in this state, the pin 30 is retained by the grommet 20 so as not to be detached therefrom (see FIG. 5). When in the state in which the pin 30 is retained by the grommet 20 in a detachment-preventing manner, the pin 30 is forced in still deeper, and the engagement protrusions 26 of the elastic members 25 are engaged with the second lock groove 36, the pair of lock members 40, 40 are pressed by the peripheral edges of the openings 23 and retracted into the openings 23, with the pin 30 being retained by the grommet 20 at the forcing-in position (FIG. 6). As described above, in the first embodiment, the first lock groove 35 and the elastic members 25 constitute the first engagement means of the present invention, and the second lock groove 36 and the elastic members 25 constitute the second engagement means of the present invention.

Next, the method of using the clip 10, constructed as described above, is illustrated.

First, as illustrated in FIG. 1, the shaft portion 32 and the pair of first lock members 40, 40 of the pin 30 are matched with the insertion hole 21a and the pair of openings 23, 23 of the grommet 20, and the pin 30 is forced into the grommet 20. Then, the shaft portion 32 is inserted into the cylinder portion 22 through the insertion hole 21a, and the pair of lock members 40, 40 are pressed by the insertion hole 21a to be warped inwardly. When the first lock members 40, 40 reach the openings 23, 23, they are elastically restored to protrude from the openings 23, 23 (see FIG. 6). At the same time, the tapered distal end portion 34a of the shaft portion 32 enters the interior of the plurality of elastic members 25, and presses the engagement protrusions 26 to outwardly deflect the plurality of elastic members 25. When the engagement protrusions 26 reach the first lock groove 35, the plurality of elastic members 25 are elastically restored, and the engagement protrusions 26 are engaged with the first lock groove 35. As a result, it is possible to assemble the pin 30 to the grommet 20 so as to prevent its detachment therefrom, with the pair of first lock members 40, 40 protruding from the openings 23, 23 as illustrated in FIG. 5.

At the shaft-portion-32-distal-end-side peripheral edge of the first lock groove 35, there is provided the stopper wall 38 protruding further outwards than the partition wall 37 provided at the shaft-portion-32-proximal-end-side peripheral edge of the first lock groove 35 (see FIG. 5), so, even when there is exerted an external force that would cause the pin 30 to be separated from the grommet 20, the stopper wall 38 is caught by the engagement protrusions 26 of the elastic members 25, making it difficult for the elastic members 25 to be detached from the first lock groove 35; as a result, it is possible to prevent the pin 30 temporarily assembled to the grommet 20 from being easily pulled out of the grommet 20. This proves effective, for example, when the clip is conveyed in a state in which the pin 30 is assembled to the grommet 20.

Next, with the mounting hole 3 being matched with the insertion hole 6, the cover member 5 is arranged on the vehicle body panel 1, and the clip 10 in the above-mentioned state is inserted from the cover member 5 side (see FIG. 1). Then, the clip 10 is passed through the insertion hole 6, and the pair of first lock members 40, 40 protruding from the openings 23, 23 are pressed by the inner periphery of the mounting hole 3 to be warped inwardly. When the first engagement step portions 41, 41 reach the back side of the mounting hole 3, the first lock members 40, 40 are elastically restored, and the first engagement step portions 41, 41 are engaged with the back side peripheral edge of the mounting hole 3, and, at the same time, the head portion 21 of the grommet 20 is engaged with the front side peripheral edge of the insertion hole 6, with the result that the vehicle body panel 1 and the cover member 5 are held between the head portion 21 and the first engagement step portions 41, 41, thus making it possible to mount the cover member 5 to the vehicle body panel 1.

As illustrated in FIG. 5, the depth D1 of the first lock groove 35 is larger than the depth D2 of the second lock groove 36, whereby the engagement protrusions 26 of the elastic members 25 can be engaged with the first lock groove 35 at a deeper position than when they are engaged with the second lock groove 36 (see FIG. 6), so it is possible to make it difficult for the engagement protrusions 26 of the elastic members 25 to be detached from the first lock groove 35. Further, as illustrated in FIG. 5, in this embodiment, the width W1 of the first lock groove 35 is larger than the width W2 of the second lock groove 36, whereby the engagement protrusions 26 of the elastic members 25 can be engaged with the first lock groove 35 in a larger contact area than when they are engaged with the second lock groove 36 (see FIG. 6), so it is possible for the engagement protrusions 26 of the elastic members 25 to be firmly engaged with the first lock groove 35. As a result, when the clip 10 is inserted into the insertion hole 6 and the mounting hole 3 by pressing the flange portion 31 of the pin 30, it is possible to prevent the elastic members 25 of the grommet 20 from being detached from the first lock groove 35 and being fit-engaged with the second lock groove 36. At the same time, the engagement protrusions 26 of the elastic members 25 are firmly engaged with the first lock groove 35, making it possible to maintain in a stable manner the state in which the pair of first lock members 40, 40 protrude from the openings 23, 23.

As illustrated in FIG. 5, in the state in which the cover member 5 is attached to the vehicle body panel 1 by the clip 10, a predetermined gap is formed between the head portion 21 of the grommet 20 and the flange portion 31 of the pin 30, so it is possible to force the pin into the grommet 20. Thus, when the cover member 5 is to be detached from the vehicle body panel 1 in order, for example, to perform maintenance on the engine room, the pin 30 is further forced-in in the above-mentioned state, whereby the elastic members 25 are warped outwardly, and the engagement protrusions 26 climb over the partition wall 37 to be engaged with the second lock groove 36. At the same time, the pair of first lock members 40 are pressed to be inwardly warped by the peripheral edges of the openings 23 on the cylinder-portion-22-distal-end side, and are retracted through the openings 23, 23, and, as illustrated in FIG. 6, the first lock engagement step portions 41 are detached from the back side peripheral edge of the mounting hole 3, and the engagement state is canceled. Thus, by raising the cover member 5 from the vehicle body panel 1, the clip 10 is pulled out of the mounting hole 3, making it possible to detach the cover member 5 from the vehicle body panel 1.

At this state, the engagement protrusions 26 of the elastic members 25 are engaged with the first lock groove 35, and the distal-end side peripheral edges of the openings 23 are arranged in the vicinity of the proximal end portions of the first lock members 40, with the first lock members 40 protruding from the openings 23. Thus, when the pin 30 is forced into the grommet 20, the first lock members 40 are immediately pressed by the distal-end side peripheral edges of the openings 23 to be warped inwardly, so it is possible to reduce the forcing-in stroke for the pin 30, thereby achieving an improvement in detachment workability.

As described above, the depth D1 of the first lock groove 35 is larger than the depth D2 of the second lock groove 36 (D1>D2), so, in the state in which the elastic members 25 are engaged with the second lock groove 36, the elastic members 25 are more diverged than when they are engaged with the first lock groove 35 (see FIGS. 5 and 6), with the result that the elastic members 25 are easily returned to the first lock groove 35 side due to their elastic force. Thus, after the first lock members 40 are retracted into the openings 23 to detach the clip 10 from the mounting hole 3, the elastic members 25 are easily restored to the state in which they are engaged with the first lock groove 35 by slightly and reversely pushing the pin 30 from the distal end thereof into the grommet 20, thereby restoring the state in which the first lock members 40 protrude from the openings 23, so re-use of the clip 10 is facilitated.

As described above, the clip 10 can be fixed to the mounting hole 3 by the simple operation of the putting it into the mounting hole 3 after assembling the pin 30 to the grommet 20. On the other hand, the clip 10 can be easily detached from the mounting hole 3 by a relatively simple operation of pulling it out after forcing the pin 30 further into the grommet 20, with the result that it is possible to achieve an improvement in terms of attachment/detachment workability for the cover member 5 with respect to the vehicle body panel 1.

Further, in the clip 10, the outer periphery of the grommet is not forcibly diverged by forcing-in the pin as in the related art, so the diverged portion does not undergo transition to the diverged state with the passage of time. Furthermore, the pair of first lock members 40, 40 provided on the pin 30 are forcibly reduced in diameter by the peripheral edge portions of the openings 23 of the grommet 20, so the clip 10 can be reliably detached from the mounting hole 3.

Further, the grommet 20 is not diverged, so when pulling the clip 10 out of the mounting hole 3, it is not caught by the peripheral edge thereof, thus securing a satisfactory detachment workability for the clip 10. Further, since the grommet 20 is not equipped with a portion to be diverged, it is possible to adopt a relatively hard material such as synthetic resin, thus enlarging the range for material selection.

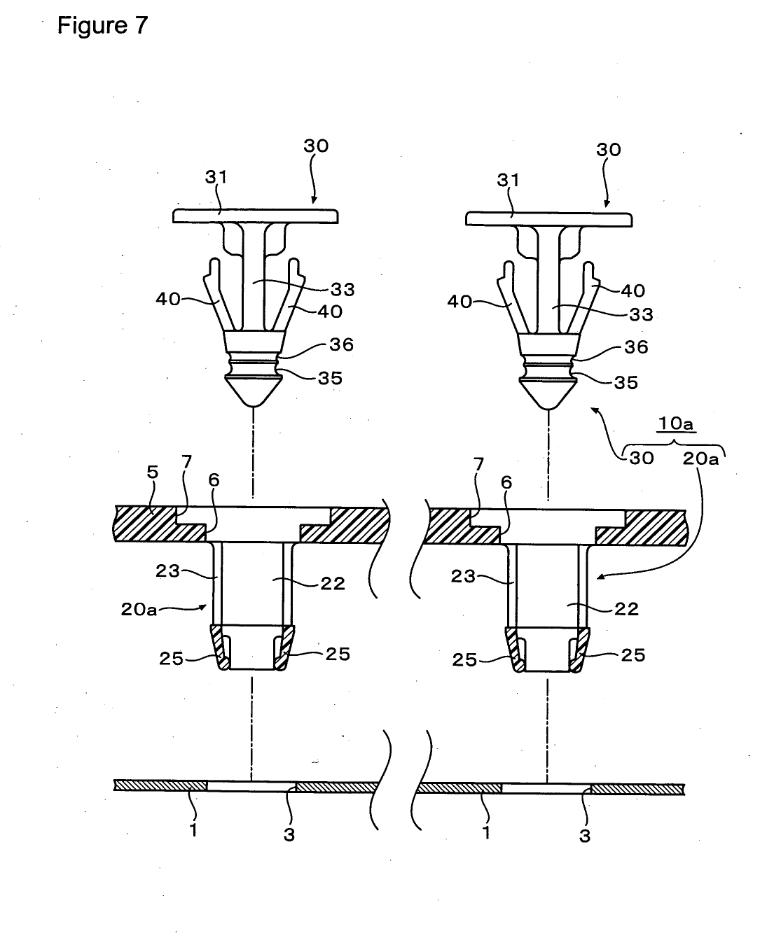

FIG. 7 illustrates a two-piece clip according the second embodiment of the present invention. The portions that are substantially the same as those of the above-mentioned embodiment are indicated by the same reference symbols, and a description thereof is omitted.

In the above-mentioned embodiment, the grommet 20 is provided separately from the vehicle body panel 1 and the cover member 5, whereas in a two-piece clip 10a according to this embodiment (hereinafter referred to as “clip 10a”), a grommet 20a is integrally formed in the cover member 5 to be detachably attached to the vehicle body panel 1. More specifically, the grommet 20a has the cylinder portion 22 protruding from the back side peripheral edge of the insertion hole 6 formed in the cover member 5, and there is provided no head portion 21.

In the clip 10a, it is constructed in such manner that the outer periphery of the grommet is not diverged, so the grommet can be formed integrally with the mounting component such as the cover member 5. In this embodiment, the grommet 20a is formed integrally with the cover member 5, and is not detached from the cover member 5, so it is possible to achieve an improvement in terms of workability when mounting the pin 30 to the grommet 20a and removing the pin 30 from the grommet 20a.

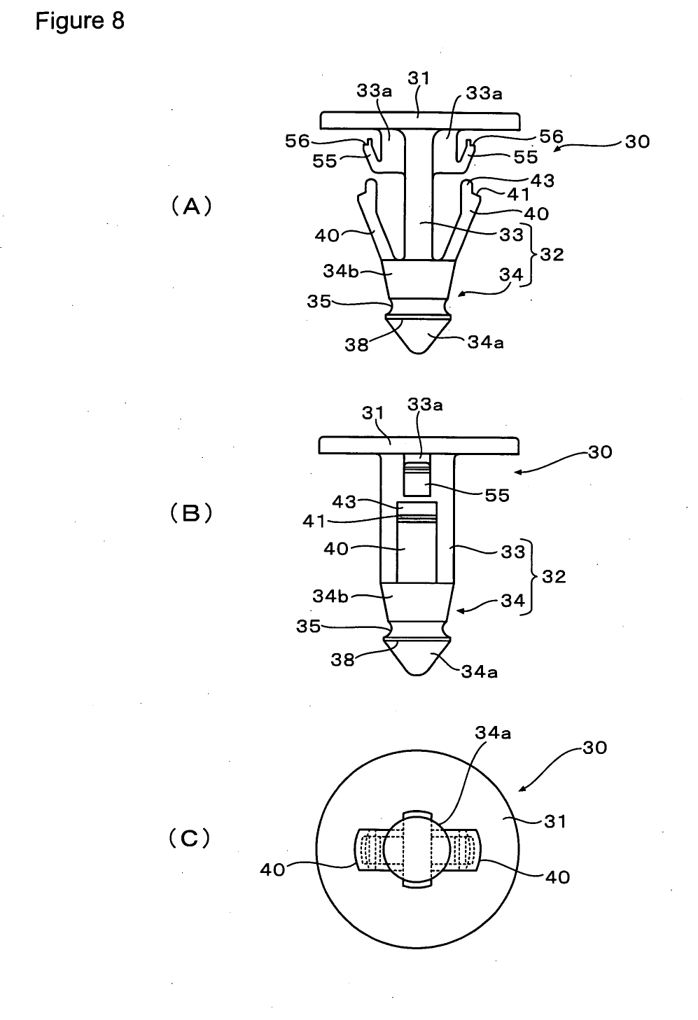

FIGS. 8 through 10 illustrate a two-piece clip according the third embodiment of the present invention. The portions that are substantially the same as those of the above-mentioned embodiments are indicated by the same reference symbols, and a description thereof is omitted.

A two-piece clip 10b according to the third embodiment (hereinafter referred to as “clip 10b”) differs from that of the first and second embodiments in the structure of a second engagement means, the means being for further forcing-in, in the state in which the pin 30 is held by the grommet 20 so as not to be detached therefrom, the pin 30 to draw the first lock members 40 into the openings 23, and for retaining the pin 30 at that forcing-in position.

Regarding the first engagement means, the means being for retaining the pin 30 in the grommet 20 so as to prevent its detachment therefrom, with the first lock members 40 protruding from the openings 23, it is of the same structure as that of the first and second embodiments. That is, in the third embodiment also, the first lock groove 35 and the elastic members 25 constitute the first engagement means of the present invention.

In the following, the differences in structure of this embodiment are illustrated. As illustrated in FIGS. 8A and 8B, the proximal end portion 34b of the diverged portion 34, which is connected to the distal end portion of the shaft main body 33 protruding perpendicularly from the flange portion 31 of the pin 30, extends longer toward the distal end in the axial direction as compared with that in the first and second embodiments. Further, unlike the above-mentioned embodiments, solely the first lock groove 35 is provided in the portion of the diverged portion 34 between the distal end 34a and the proximal end 34b, with no second lock groove 36 being provided. Further, from the distal ends of the protrusions 33a, 33a protruding both side surfaces on the proximal end side of the shaft main body 33, there extend a pair of second lock members 55, 55, which are capable of warp and extend obliquely outwards in a fluke-like fashion toward the flange portion 31 while matched with the first lock members 40, 40. Second engagement step portions 56 are provided at the distal ends of the second lock members 55.

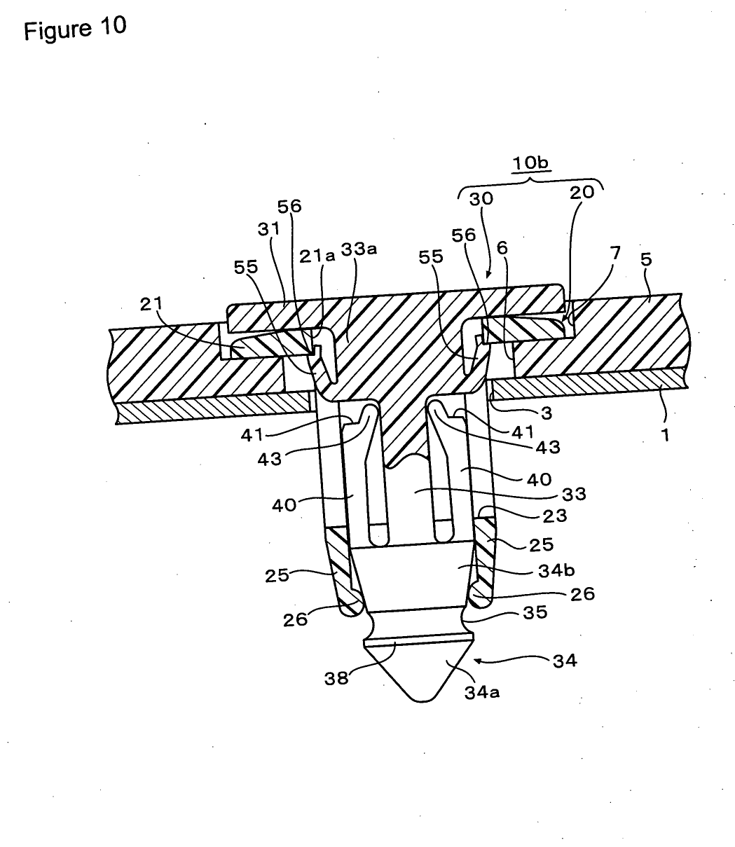

When, in the state in which the pin 30 is retained by the grommet 20 so as not to be detached therefrom, the pin 30 is further forced in to retract the first lock members 40 into the openings 23, the second engagement step portions 56 of the second engagement portions 55 are engaged with the proximal-end-side peripheral edges of the openings 23 of the grommet 20 (see FIG. 10). That is, in the third embodiment, the second lock members 55 and the proximal-end-side peripheral edges of the openings 23 constitute the second engagement means of the present invention.

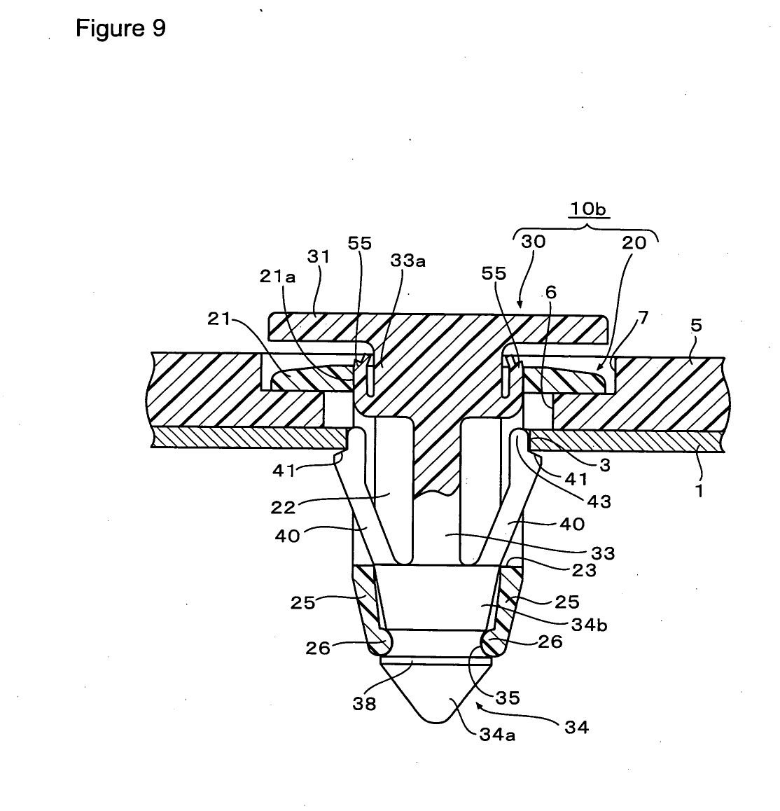

As in the first and second embodiments, in the clip 10b constructed as described above, when the pin 30 is forced into the grommet 20 to a predetermined depth, the engagement protrusions 26 of the elastic members 25 are engaged with the first lock groove 35, and the pin 30 is retained so as not to be detached, with the pair of first lock members 40, 40 protruding from the openings 23, 23. At this state, the second lock members 55, 55 are pressed by the inner periphery of the insertion hole 21a to be warped inwardly. By forcing the clip 10b into the mounting hole 3 in this state, the first engagement step portions 41 of the pair of lock members 40, 40 protruding from the openings 23 are engaged with the back side peripheral edge of the mounting hole 3, making it possible to attach the cover member 5 to the vehicle body panel 1 via the clip 10b as illustrated in FIG. 9.

When, after this, the clip 10b is to be detached from the mounting hole 3, the pin 30 in the state as illustrated in FIG. 9 is forced in still deeper as illustrated in FIG. 10, whereby the elastic members 25 are warped outwardly, and the engagement protrusions 26 are detached from the first lock groove 35, with the pair of first lock members 40, 40 being pressed by the distal-end-side peripheral edges of the openings 23 to be warped inwardly and retracted into the openings 23. At the same time, the second lock members 55, 55 are elastically restored, and the second engagement step portions 56 are engaged with the proximal-end-side peripheral edges of the openings 23, with the pin 30 being retained by the grommet 20 at that forcing-in position to maintain the first lock members 40 in the retracted state, so it is possible to pull the pin 30 out of the mounting hole 3 to remove it therefrom.

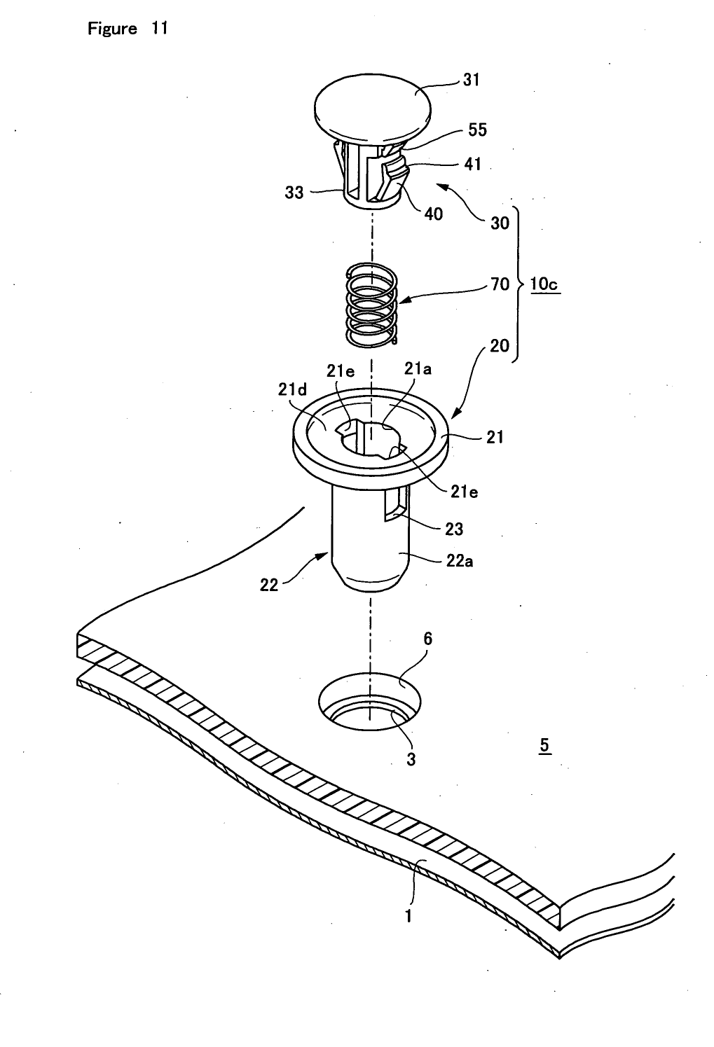

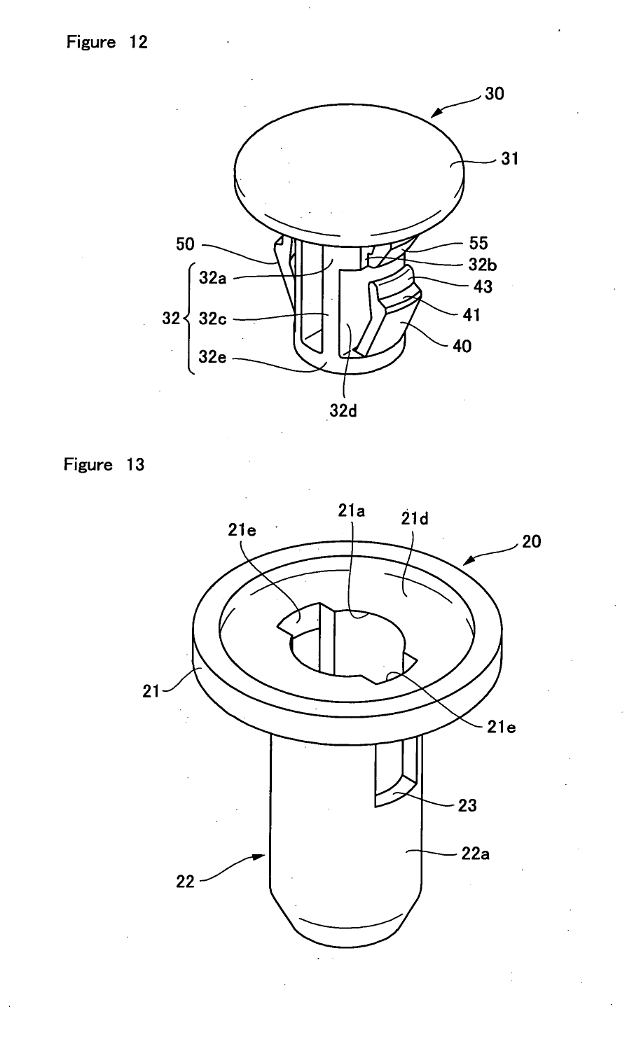

FIGS. 11 through 18 illustrate a two-piece clip according to the fourth embodiment of the present invention. The portions that are substantially the same as those of the above-mentioned embodiments are indicated by the same reference symbols, and a description thereof is omitted.

A two-piece clip 10 according to the third embodiment (hereinafter referred to as “clip 10c”) is equipped, apart from the grommet 20 and the pin 30, an urging means (which is a coil spring 70 in this embodiment), which is provided between the grommet 20 and the pin 30 and urges the pin 30 in a direction opposite to the forcing-in direction with respect to the grommet 20.

Referring to FIGS. 11, 13, and 15 through 18, the grommet 20 is described, mainly about where it differs from the above-mentioned embodiments; formed in the surface of the head portion 21 is an accommodation recess 21d into which the flange portion 31 of the pin 30 is put, and a pair of cutout grooves 21e, 21e extending through the head portion 21 are formed at opposing peripheral edge portions of the insertion hole 21a formed at the center of the bottom of the accommodation recess 21d.

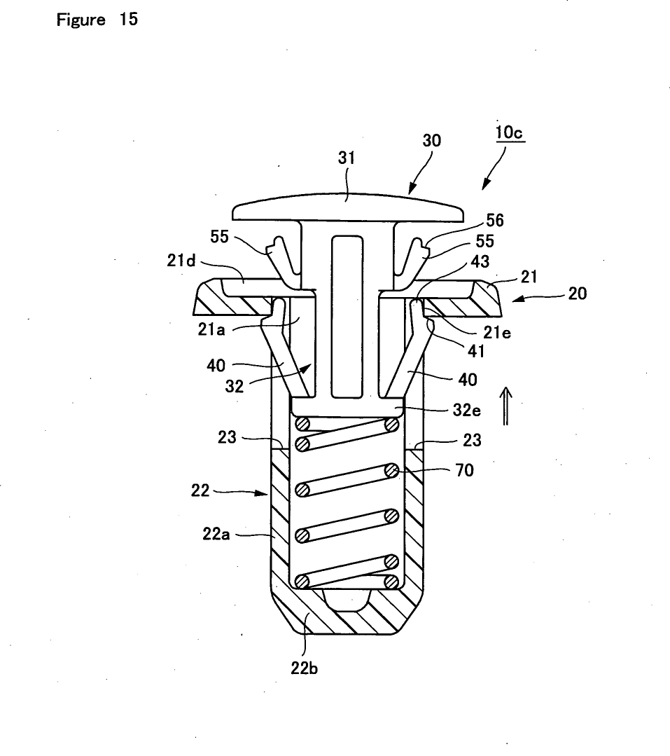

The cylinder portion 22 provided on the back side of the head portion 21 has a cylindrical peripheral wall 22a extending from the peripheral edge of the back side of the insertion hole 21a of the head portion 21, and a bottom portion 22b connected to the opening at the distal end of the peripheral wall 22a, with the whole being substantially formed as a bottomed cylinder. As illustrated in FIG. 15, one end of the coil spring 70 is supported by the inner end surface of the bottom portion 22b.

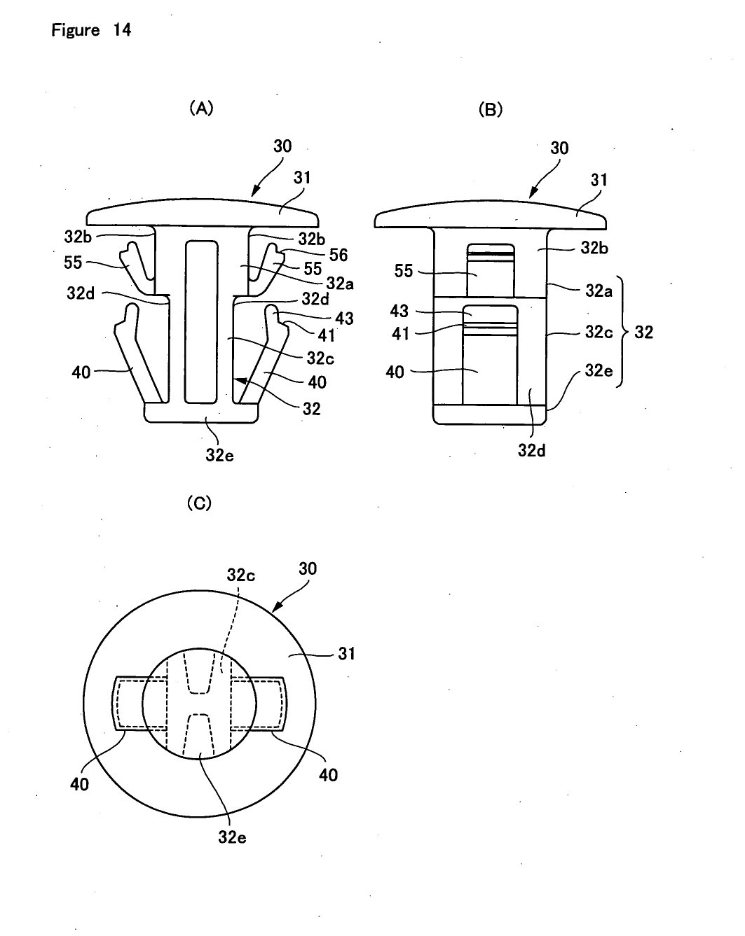

On the other hand, the pin 30 is described with reference to FIGS. 11, 12, 14, and 15 through 18. The shaft portion 32 of the pin 30 includes a proximal portion 32a protruding from the back side of the flange portion 31, with its both side portions 32b, 32b constituting flat surfaces, an intermediate portion 32c extending perpendicularly from the distal end of the proximal portion 32a, with its opposing side portions 32d, 32d being formed as flat surfaces, and a disc-like distal end portion 32e formed so as to be continuous with the intermediate portion 32c (see FIGS. 14A through 14C). The other end of the coil spring 70 is supported by the forward end surface of the disc-like distal end portion 32e. Further, the pair of first lock members 40, 40 extend from the proximal end surface of the distal end portion 32e and on both opposing sides 32d of the intermediate portions 32c, and the pair of second lock members 55, 55 extend from the opposing distal end sides of both side portions 32b of the proximal portion 32a.

The coil spring 70 constituting the urging means is provided between the grommet 20 and the pin 30 constructed as described above. This is described along with the procedures by which the pin 30 is assembled to the grommet 20; first, the coil spring 70 is inserted into the cylinder portion 22 of the grommet 20, and one end thereof is supported by the inner end surface of the bottom portion 22b. In this state, the first lock members 40, 40 are matched with the cutout grooves 21e, 21e, and the shaft portion 32 is inserted into the cylinder portion 22 through the insertion hole 21a, with the other end of the coil spring 70 being supported by the forward end surface of the distal end portion 32e of the shaft portion 32. The pin 30 is forced into the grommet 20 against the urging force of the coil spring 70.

Then, the first lock members 40, 40 are pressed by the inner peripheries of the cutout grooves 21e, 21e to be warped inwardly, and, when the first engagement step portions 41, 41 pass the cutout grooves 21e, 21e to reach the openings 23, the first lock members 40, 40 are elastically restored, and the first engagement step portions 41, 41 are engaged with the proximal end side peripheral edges of the openings 23. As illustrated in FIG. 15, the pin 30 is retained by the grommet 20 so as not to be detached, with the first lock members 40 protruding from the openings 23. That is, in the fourth embodiment, the first lock members 40 and the proximal end side peripheral edges of the openings 23 constitute the first engagement means.

At this state, the coil spring 70 is provided in a compressed state between the grommet 20 and the pin 30, with one end thereof being supported by the inner end surface of the bottom portion 22b of the cylinder portion 22, and the other end thereof being supported by the forward end surface of the distal end portion 32e of the shaft portion 32. Thus, the pin 30 is assembled to the grommet 20, with the pin 30 being urged in a direction (indicated by the arrow of FIG. 15) opposite to the forcing-in direction with respect to the grommet 20.

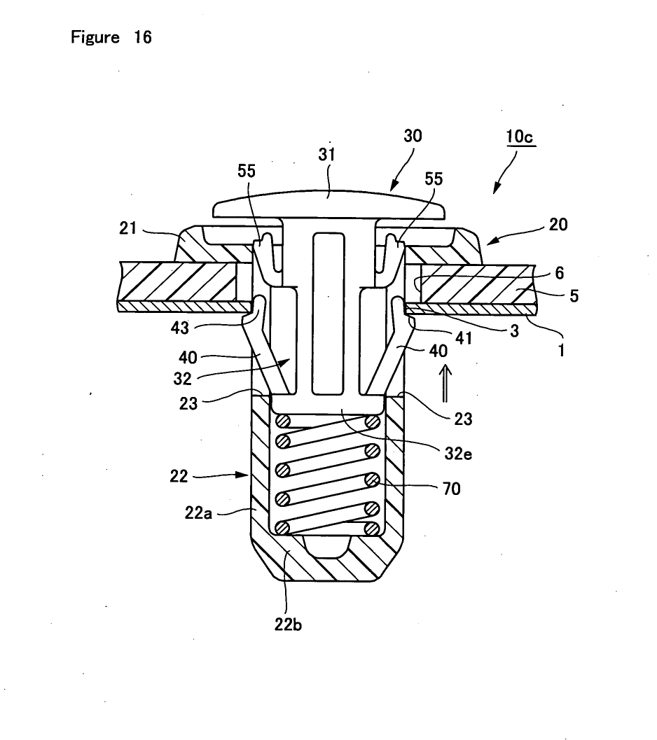

As described above, as in the case of the clips of the above-mentioned embodiments, the clip 10c of this embodiment is also inserted into the mounting hole 3, with the pair of first lock members 40, 40 protruding from the openings 23 and the pin 30 being retained by the grommet 20 so as not to be detached therefrom, whereby the first engagement step portions 41 of the first lock members 40 are engaged with the back side peripheral edge of the mounting hole 3, and, at the same time, the head portion 21 of the grommet 20 is engaged with the front side peripheral edge of the insertion hole 6, making it possible to attach the cover member 5 to the vehicle body panel 1 as illustrated in FIG. 16.

At this state, the pin 30 is urged by the coil spring 70 in a direction opposite to the forcing-in direction with respect to the grommet 20, so, as indicated by the arrow in FIG. 16, the first lock members 40 are pressed against the back side of the mounting hole 3. As a result, even when the thickness of the vehicle body panel 1, which constitutes the mounting object member, is changed due to dimensional error or the like, it can cope with flexibility, making it possible to fix the clip 10c to the mounting hole 3 in a stable manner without involving any rattling.

In some cases, the clip is fixed to the mounting hole 3 formed in a soft member such as a trim board. In the case of such a soft member, the board thickness may partially become smaller than a predetermined thickness due to permanent strain or the like. Even in such cases, the first engagement step portions 41 of the first lock member 40 are firmly engaged with the back side peripheral edge of the mounting hole 3 owing to the urging force of the coil spring 70, making it possible to fix the clip 10c to the mounting hole 3 without involving any rattling.

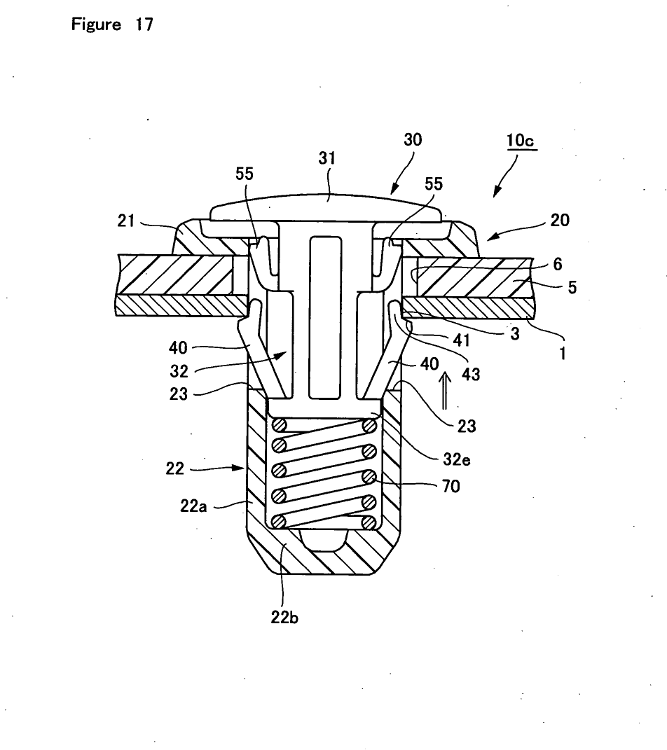

Further, even in a case in which the thickness of the vehicle body panel 1 is large as illustrated in FIG. 17, the first engagement step portions 41 of the first lock members 40 of the pin 30 pushed up by the urging force of the coil spring 70 are firmly engaged with the back side peripheral edge of the mounting hole 3, and, in this case also, it is possible to fix the clip 10c to the mounting hole 3 without involving any rattling. In this case, due to a change in plate thickness, the coil spring 70 is pushed and contracted, and the pin 30 as a whole is further forced in, causing the positions of the first engagement step portions 41 to move, so no excessive load is applied to the first lock members 40 themselves, which would occur in the related art, making it possible to effect the fixation in a stable manner.

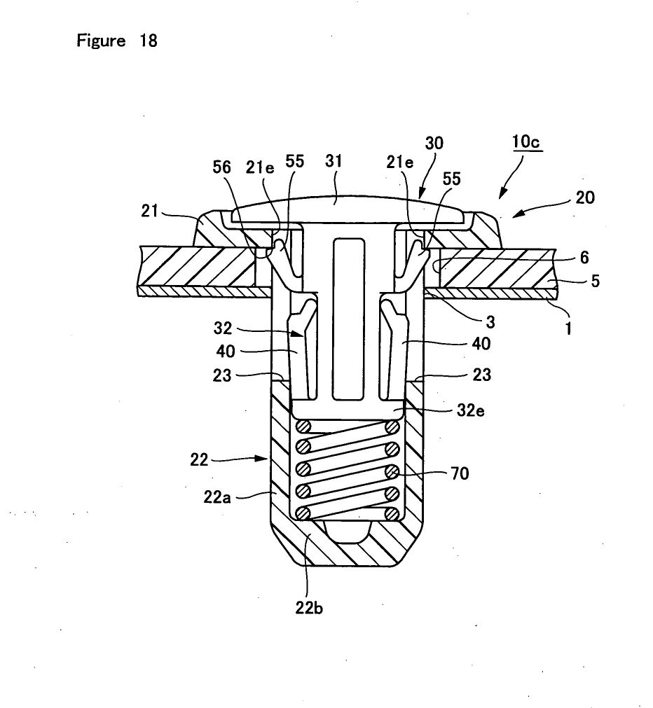

On the other hand, when the clip 10c is to be detached from the mounting hole 3, the pin 30 in the state as illustrated in FIG. 16 is further forced into the grommet 20 against the urging force of the coil spring 70, whereby, as illustrated in FIG. 18, the second lock members 55, 55 are warped inwardly by the inner peripheral edges of the cutout grooves 21e, 21e, and, at the same time, the first lock members 40, 40 are pressed by the distal end side peripheral edges of the openings 23 to be warped inwardly and retracted into the openings 23, 23, with the result that the first engagement step portions 41 are detached from the back side peripheral edge of the mounting hole 3. When the pin 30 is further forced in, and the second engagement step portions 56 of the second lock members 55 pass the cutout grooves 21e to reach the openings 23, the second lock members 55, 55 are elastically restored, and the second engagement step portions 56 are engaged with the proximal end side peripheral edges of the openings 23, with the result that the first lock members 40, 40 are maintained in the state in which they are retracted into the openings 23, making it possible to pull the clip 10c out of the mounting hole 3 and remove it therefrom. As described above, as in the third embodiment of the present invention, in this fourth embodiment of the present invention, the second lock members 55 and the proximal end side peripheral edges of the openings 23 constitute the second engagement means.

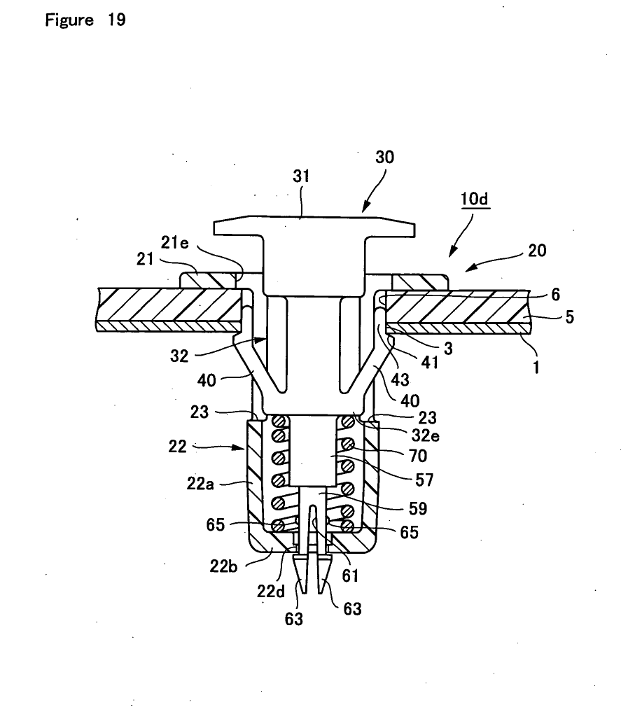

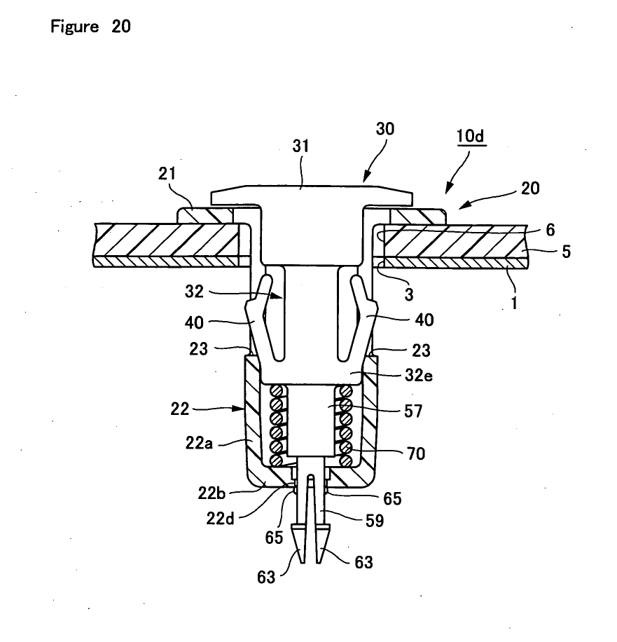

FIGS. 19 and 20 illustrate a two-piece clip according to the fifth embodiment of the present invention. The portions that are substantially the same as those of the above-mentioned embodiments are indicated by the same reference symbols, and a description thereof is omitted.

As in the fourth embodiment of the present invention, in a two-piece clip 10d (hereinafter referred to as “clip 10d”) of the fifth embodiment of the present invention, an urging means is provided between the grommet 20 and the pin 30. However, it differs from the fourth embodiment of the present invention in a first engagement means for retaining the pin 30 in the grommet 20 so as to be free from detachment, and in a second engagement unit so as to maintain the first lock members 40 in the state in which they are retracted into the openings 23.

As illustrated in FIGS. 19 and 20, an insertion hole 22d is formed in the bottom portion 22b of the grommet 20. On the other hand, the shaft portion 32 of the pin 30 has a columnar guide shaft 57 protruding from the forward end surface of the distal end portion 32e, and a protruding shaft 59 protruding from the forward end of the guide shaft 57 and reduced in diameter as compared with the guide shaft 57. In the outer periphery of the forward end of the protruding shaft 59, there protrude half-split engagement claws 63, 63 with a slit 61 being interposed therebetween, being capable of warp. Further, halfway through the protruding shaft 59 in the axial direction, and in the outer periphery of the protruding shaft 59 on the proximal portion side from the engagement claws 63,63 there protrude a pair of engagement protrusions 65, 65.

When the pin 30 is forced into the grommet 20, with the coil spring 70 fitted onto the outer periphery of the guide shaft 57, the outer periphery of the half-split engagement claws 63, 63 is pressed to be warped inwardly, and the engagement claws 63, 63 comes out to the protrusion side (outer side) of the insertion hole 22d to be engaged with the protrusion side peripheral edge of the insertion hole 22d. Thus, the pin 30 is retained by the grommet 20 so as not to be detached, with the first lock members 40 protruding from the openings 23. That is, in the fifth embodiment, the engagement claws 63 provided at the forward end of the shaft portion 32 of the pin 30 and the insertion hole 22d provided at the bottom portion 22b of the cylinder portion 22 constitute the first engagement means.

When the assembled clip 10d is inserted into the mounting hole 3, the first engagement step portions 41 are engaged with the back side peripheral edge of the mounting hole 3, and the clip 10 is fixed to the mounting hole 3 (see FIG. 19). Further, in the fifth embodiment, the protrusion shaft 59 of the shaft portion 32 of the pin 30 are movably inserted in respect of the insertion hole 22d, so it is possible to secure the requisite amount by which the pin 30 is inserted into the grommet 20. Further, since the guide shaft 57 of the shaft portion 32 of the pin 30 is passed through the coil spring 70, making it possible to suppress inclination and positional deviation of the coil spring 70.

When the clip 10d is to be detached from the mounting hole 3, in the state in which the clip 10 is fixed to the mounting hole 3 as illustrated in FIG. 19, the pin 30 is further forced in as illustrated in FIG. 20, whereby the pair of engagement protrusions 65, 65 are engaged with the back side peripheral edge of the insertion hole 22d, and the first lock members 40 are maintained in the state in which they are retracted into the openings 23, making it possible to pull the clip 10 out of the mounting hole 3. That is, in the fifth embodiment, the engagement protrusions 65 provided halfway through in the axial direction of the protrusion shaft 59 of the pin 30 and the insertion hole 22d provided at the bottom portion 22b of the cylinder portion 22 constitute the second engagement means.

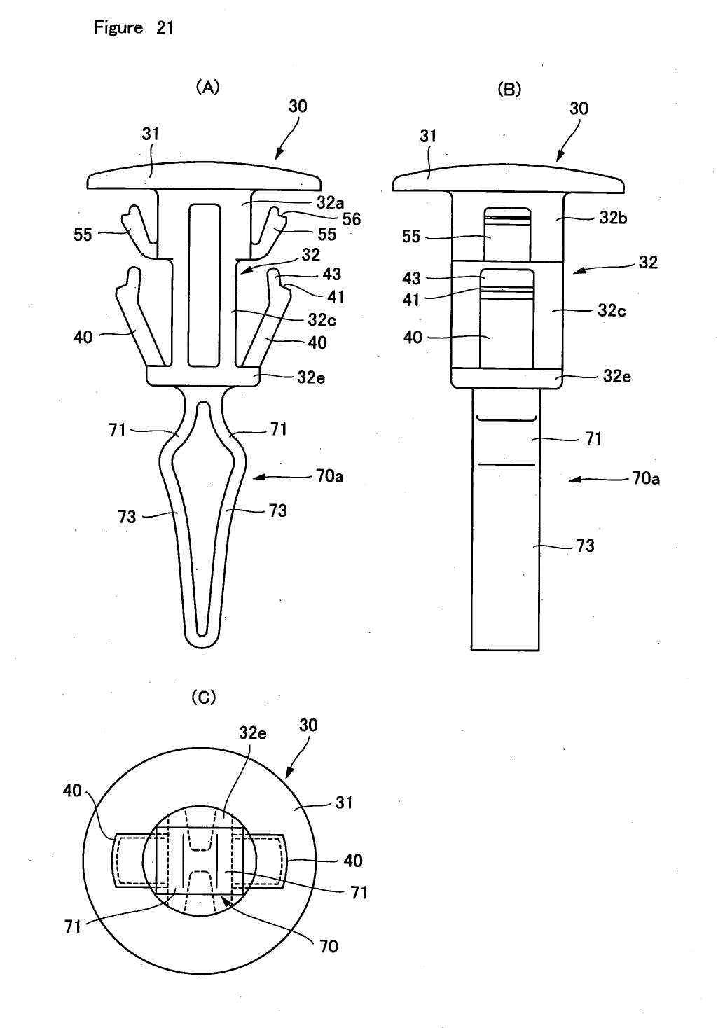

FIGS. 21 through 23 illustrate a two-piece clip according to the sixth embodiment of the present invention. The portions that are substantially the same as those of the above embodiments are indicated by the same reference symbols, and a description thereof is omitted.

As in the fourth and fifth embodiments, in a two-piece clip 10e of the sixth embodiment (hereinafter referred to as “clip 10e”), an urging means is provided between the grommet 20 and the pin 30, and it differs from the fourth and fifth embodiments in the structure by which an urging force by the urging means is imparted.

That is, the clip 10e of this embodiment does not use the coil spring 70 as the urging means. Instead, it uses a resin spring 70a formed integrally with the pin 30 as the urging means. As illustrated in FIGS. 21A through 21C, the resin spring 70a includes a pair of support members 71, 71 protruding obliquely outwards from the distal end portion 32e of the shaft portion 32 of the pin 30 so as to be gradually away from each other, and spring members 73, 73 protruding obliquely inwards from the distal ends of the support members 71, 71 so as to be gradually close to each other, with their end portions being connected with each other.

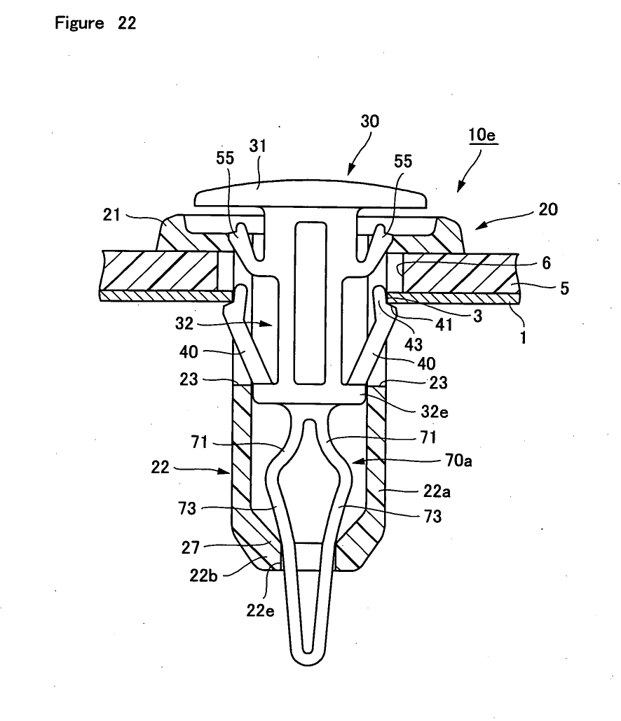

On the other hand, as illustrated in FIG. 22, the grommet 20 has an elongated-hole-shaped insertion hole 22e, and the peripheral edge of the insertion hole 22e constitutes a spring contact portion 27 inclined obliquely upwards.

The first engagement means for retaining the pin 30 in the grommet 20 so as to prevent its detachment, and the second engagement means for maintaining the first lock members 40 in the state in which they are retracted into the openings 23, are the same as those of the fourth embodiment.

When the pin 30 is inserted into the grommet 20, the spring members 73, 73 of the resin spring 70a are inserted into the insertion hole 22e, and the first engagement step portions 41 of the first lock members 40 are engaged with and retained by the proximal-end-side peripheral edges of the openings 23 so as not to be detached. At this state, the spring members 73, 73 are brought into contact with the spring contact portion 27 provided in the grommet 20 and are warped thereby, so, due to the elastic restoring force thereof, the pin 30 is urged in a direction opposite to the direction in which the pin 30 is forced into the grommet 20.

As illustrated in FIG. 22, the clip 10e with the pin 30 assembled to the grommet 20 is inserted into the mounting hole 3, whereby the first engagement step portions 41 are engaged with the back side peripheral edge of the mounting hole 3, thereby fixing the clip 10e to the mounting hole 3. At this state, the first lock members 40 are engaged with the mounting hole 3, whereby a state is attained in which the pin 30 is further forced in, and the spring members 73, 73 are strongly brought into contact with the spring contact portion 27 of the grommet 20 and are warped; the elastic restoring force thereof is larger than in the above-mentioned mounted state, and the first lock members 40 are firmly pressed against the back side of the mounting hole 3, making it possible to fix the clip 10e to the mounting hole 3 without involving any rattling.

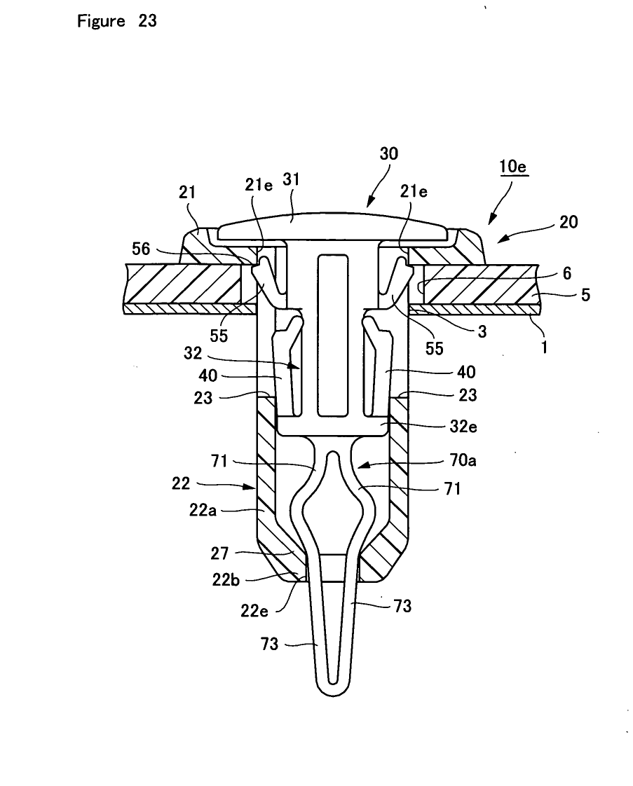

When the clip 10e is to be detached from the mounting hole 3, the pin 30 in the above state is further forced in against the urging force of the resin spring 70a, whereby, as illustrated in FIG. 23, the second engagement step portions 56 of the second lock members 55 are engaged with the proximal end side peripheral edges of the openings 23, and the first lock members 40 are maintained in the state in which they are retracted into the openings 23, making it possible to pull the clip 10e out of the mounting hole 3.

What is claimed is:

1. A two-piece clip comprising a grommet and a pin inserted into the grommet, and adapted to be fixed to a mounting hole,
wherein the pin has a flange portion, a shaft portion protruding from one surface of the flange portion, and a first lock member provided as to be warped to the outer periphery of the shaft portion and adapted to be engaged with a peripheral edge of the mounting hole,
wherein the grommet has a cylinder portion into which the shaft portion is inserted and which has an inner diameter smaller than the outer diameter of the flange portion, and an opening which is formed in a peripheral wall of the cylinder portion and from and into which the first lock member is projected and retracted,
wherein the two-piece clip further comprises a first engagement means for retaining the pin with respect to the grommet so as to prevent detachment thereof, with the pin being forced into the grommet to a predetermined depth, the first lock member protruding from the opening, and a predetermined gap being provided between the grommet and the flange portion, and
wherein the two-piece clip further comprises a second engagement means which is constructed such that, by further forcing the pin into the grommet from the state in which the pin is retained with respect to the grommet so as to prevent detachment thereof by the first engagement means, the first lock member is pressed against the peripheral edge of the opening and drawn into the opening, with the pin being retained by the grommet at that forcing-inposition.

2. A two-piece clip according to claim 1, wherein the first engagement means includes a first lock groove formed in the outer periphery of the forward end portion of the shaft portion of the pin, and an elastic member formed at the forward end portion of the cylinder portion of the grommet so as to be capable of warp, and
wherein the second engagement means includes a second lock groove formed in the outer periphery of the shaft portion of the pin on the proximal end portion side of the first lock groove, and the elastic member.

3. A two-piece clip according to claim 2, wherein the first lock groove is formed so as to be deeper than the second lock groove with respect to the outer peripheral surface of the shaft portion.

4. A two-piece clip according to claim 2, wherein, in the shaft-portion-distal-end-side peripheral edge of the first lock groove, there is formed a stopper wall protruding further outwards than the shaft-portion-proximal-end-side peripheral edge of the first lock groove.

5. A two-piece clip according to claim 2, wherein, when the elastic member is engaged with the first lock groove, and the first lock member protrudes from the opening, the cylinder-portion-distal-end-side peripheral edge of the opening is situated in the vicinity of the proximal end portion of the first lock member.

6. A two-piece clip according to claim 1, wherein the first engagement means includes the first lock groove formed in the outer periphery of the forward end portion of the shaft portion of the pin, and the elastic member formed at the forward end portion of the cylinder portion of the grommet so as to be capable of warp, and
wherein the second engagement means includes a second lock member formed on the shaft portion of the pin on the proximal end portion side of the first lock member, and a proximal-end-side peripheral edge of the opening of the cylinder portion of the grommet.

7. A two-piece clip according to claim 6, wherein, in the shaft-portion-distal-end-side peripheral edge of the first lock groove, there is formed a stopper wall protruding further outwards than the shaft-portion-proximal-end-side peripheral edge of the first lock groove.

8. A two-piece clip according to claim 6, wherein, when the elastic member is engaged with the first lock groove, and the first lock member protrudes from the opening, the cylinder-portion-distal-end-side peripheral edge of the opening is situated in the vicinity of the proximal end portion of the first lock member.

9. A two-piece clip according to claim 1, wherein the grommet is formed integrally with a component to be fixed to the mounting hole.
